(19) United States
(12) Patent Application Publication
(10) Pub. No.: US 2015/0341842 A1
(43) Pub. Date: Nov. 26, 2015

(54) WIRELESS DEVICE POWERED BY MEMS WITH ADAPTIVE COMMUNICATIONS

(71) Applicant: BROADCOM CORPORATION, IRVINE, CA (US)

(72) Inventor: Pieter Vorenkamp, Laguna Niguel, CA (US)

(73) Assignee: BROADCOM CORPORATION, IRVINE, CA (US)

(21) Appl. No.: 14/712,568

(22) Filed: May 14, 2015

Related U.S. Application Data
(60) Provisional application No. 62/000,672, filed on May 20, 2014.

(51) Int. Cl. H04W 40/10; H04W 72/04

(52) U.S. Cl. CPC H04W 40/10; H04W 72/0473

(57) ABSTRACT

A wireless device includes a wireless interface, a Micro Electro-Mechanical System (MEMS) energy harvesting component, energy storage coupled to the MEMS energy harvesting component, and processing circuitry. The processing circuitry is configured to determine an amount of energy collected by the MEMS energy harvesting component or stored in the energy storage in response to an energy collection event, based upon the amount of energy collected, determine wireless communication operations, and communicate with a remote device via the wireless interface according to the determined wireless communication operations. The determined wireless communication operations may be a communication format for use in communicating with the remote device, a communication frequency band for use in communicating with the remote device, an amount of data to be transmitted to the remote device, the amount of energy collected for the energy collection event, or a number of transmissions and receipts to communicate with the remote device.

### CROSS REFERENCE TO RELATED PATENTS/PATENT APPLICATIONS

The present U.S. Utility patent application claims priority pursuant to 35 U.S.C. §119(e) to U.S. Provisional Application No. 62/000,672, entitled “CLIENT DEVICES HAVING MEMS SENSORS TO SUPPORT PREMISES SECURITY,” filed May 20, 2014, which is hereby incorporated herein by reference in its entirety and made part of the present U.S. Utility patent application for all purposes.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND

1. Technical Field

The present disclosure relates to communications devices; and more particularly to wireless communication devices incorporating Micro Electro-Mechanical Systems (MEMS) for device powering.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11x, Bluetooth, wireless wide area networks (e.g., WiMAX), advanced mobile phone services (AMPS), digital AMPS, global system for mobile communications (GSM), North American code division multiple access (CDMA), Wideband CDMA, local multi-point distribution systems (LMDS), multi-channel-multi-point distribution systems (MMDS), radio frequency identification (RFID), Enhanced Data rates for GSM Evolution (EDGE), General Packet Radio Service (GPRS), and many others. Communication systems may also operate according to propriety formats and formats that are modified standard formats. Typically, the communication format is selected to suit a particular need and/or implementation.

Micro Electro-Mechanical Systems (MEMS) devices are also well known. These devices may be formed in a silicon substrate along with other electronics. These devices operate to convert between electrical energy and mechanical energy and between electrical energy and thermal energy. The Internet of Things (IoT) contemplates that objects that form part of our everyday lives can communicate through various networks, including the Internet. These objects will include communication interfaces, wireless interfaces in many instances and may be powered by MEMS devices.

### BRIEF DESCRIPTION OF THE SEVERAL VIEWS OF THE DRAWING(S)

FIG. 1 is a system diagram illustrating premises having a plurality of client devices installed therein;

FIG. 2 is a block diagram illustrating a client device having a Micro Electro-Mechanical Systems (MEMS) energy harvesting unit according to one or more embodiments of the present disclosure;

FIG. 3 is a flow chart illustrating operation of a client device operating according to one or more embodiments of the present disclosure;

FIG. 4 is a flow chart illustrating operation of a system operating according to one or more embodiments of the present disclosure;

FIG. 5 is a flow chart illustrating operation of a client device operating according to one or more embodiments of the present disclosure;

FIG. 6 is a flow chart illustrating programming/configuration operation of a client device operating according to one or more embodiments of the present disclosure;

FIG. 7 is a flow chart illustrating programming/configuration operation of a client device operating according to one or more embodiments of the present disclosure;

FIG. 8 is a flow chart illustrating programming/configuration operation of a client device operating according to one or more embodiments of the present disclosure;

FIG. 9 is a flow chart illustrating operation of a system operating according to one or more embodiments of the present disclosure; and

FIG. 10 is a flow chart illustrating operation of a system operating according to one or more embodiments of the present disclosure.

### DETAILED DESCRIPTION

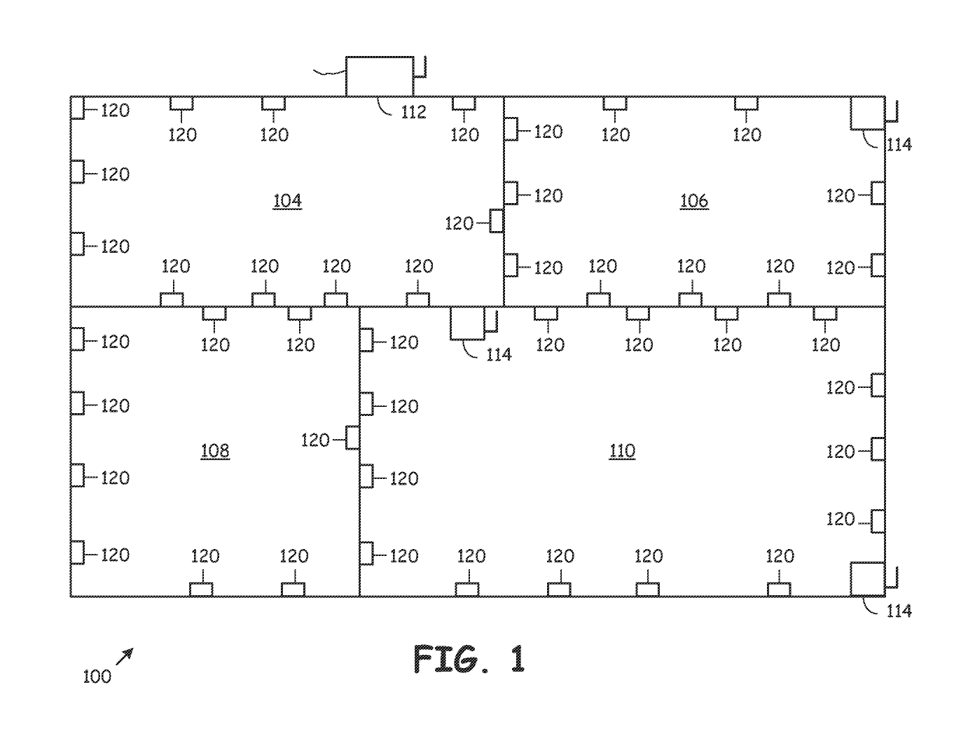

FIG. 1 is a system diagram illustrating premises 100 (home, office, warehouse, etc.) having a plurality of client devices 120 installed therein. The premises 100 of FIG. 1 have multiple rooms 104, 106, 108, and 110. The system includes a gateway 112, which may be a wireless access point, wired router, wireless router, or another device that services communication needs for the premises 100. The gateway 112 may couple the premises 100 to the Internet via a Cable Modem System, a Wide Area Network (WAN), a satellite communication system, a telephony network communication system (e.g., via xDSL communications), a powerline communications network, a cellular network, or via another communication system. The gateway may support Wireless Local Area Network (WLAN, e.g., IEEE 802.11x) communications, Wireless Personal Area Network (WPAN, e.g., Bluetooth) communications, millimeter wave, e.g., 60 GHz communications, or other wireless communications with the plurality of client devices 120. The gateway 112 may also serve as a premises security system controller, communicating with a central alarm monitoring service via a communication interface serviced thereby. Thus, the gateway 112 may serve multiple functions or may simply serve as a premises security system device.

A plurality of wireless surveillance devices 114 each includes a motion sensor, processing circuitry, and a wireless interface, allowing the devices 114 to communicatively couple to the gateway 112 and to the plurality of client devices 120. The plurality of client devices 120 each includes a Micro Electro-Mechanical Systems (MEMS) energy harvesting unit therein, which is, in combination with other electronics of the client devices 120, is used for detecting motion, detecting heat, and/or to monitor other activities within the premises 100. As is known, one type of MEMS device converts between mechanical energy and electrical energy and another type of MEMS device converts between heat energy and electrical energy. Some of the client devices 120 are of the first type and other of the client devices 120 are of the second type. The plurality of client devices 120 may service other functions as well, such as fire detection, smoke detection, light detection, air movement detection, temperature detection, etc.

The client devices 120 are mounted upon walls, ceilings, and floors of the rooms 104, 106, 108, and 110 of the premises 100. According to one aspect, the client devices operate as part of a security system that monitors the premises 100. By sensing localized vibration (mechanical energy) and/or heat energy, the MEMS energy harvesting units of the client devices 120 are able to sense motion within the premises 100 and/or the presence of heat generating sources within the premises, e.g., people, animals, etc.

The plurality of client devices 120 is distributed about the premises in various positions to gather respective meaningful data. For example, client devices 120 that sense heat energy may be placed along walls in a hallway or next to a front door to sense the presence of a person in such area. Likewise, client devices 120 that sense heat energy may be placed low on a wall so that they sense only the presence of dogs or cats. Client devices 120 that detect vibrational energy may be placed in the floor in high traffic areas to detect foot traffic in such areas. Client devices 120 that detect vibrational energy may also be placed in/on walls in relevant locations within the premises 100 to detect localized motion of people and pets.

Each of the client devices 120 is in communication with one or more of gateway 112 and/or wireless surveillance devices 114. In some constructs the client devices 120 communicate wirelessly. In other constructs the client devices 120 communicate via wired connections. The gateway 112 (or other device) has knowledge where each client device 120 is located within the premises 100 and, based upon this information, is able to determine whether a detected event is a security event or not and to operate accordingly. For example, if a client device 120 located low on a wall detects the presence of a heat source but a client device 120 located high on the same wall does not detect the presence of the heat source, the security system (of the gateway 112) may conclude that the heat source is a dog that is often times in the premises 100. However, if multiple client devices 120 detect heat energy both high and low along a wall, the security system may determine that the source of the heat energy is a person and an alarm is issued.

The client devices 120 may be installed on doors and windows to detect motion of the doors/windows. Upon a motion event of such doors and/or windows, the client devices 120 report to the security system of such event. This information may be combined with information collected by other client devices 120 to reach a conclusion to issue an alarm or to not issue an alarm. These and other operations of client devices 120 and the security system will be described further herein with reference to additional FIGS.

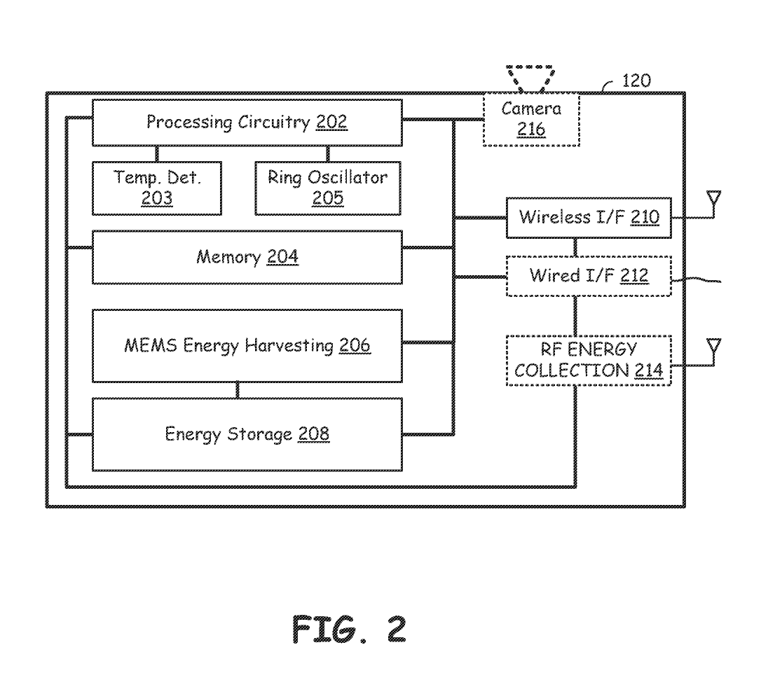

FIG. 2 is a block diagram illustrating a client device 120 having a Micro Electro-Mechanical Systems (MEMS) energy harvesting unit according to one or more embodiments of the present disclosure. The client device 120 includes processing circuitry 202, memory 204, a MEMs energy harvesting unit 206, energy storage 208, a wireless interface 210, an optional wired interface 212, an optional RF energy collection unit 214, and an optional camera 216. All of the components of the client device 120 may be contained in a relatively small package that is mountable on/in a wall, on/in a door, on/in a window, and/or in another location.

The processing circuitry 202 may include one or more of a system processor, a digital signal processor, a processing module, dedicated hardware, an application specific integrated circuit (ASIC), or other circuitry that is capable of executing software instructions and for processing data. In particular, the processing circuitry 202 is operable to support the operations described herein for the client device 120. The memory 204 may be RAM, ROM, FLASH RAM, FLASH ROM, optical memory, magnetic memory, or other types of memory that is capable of storing data and/or instructions and allowing the processing circuitry 202 to access same. The processing circuitry 202 and the memory 204 support operations of embodiments of the present disclosure as further described herein.

The client device 120 also includes one or more communication interfaces, including a wireless interface 210 that supports one or more wireless interface operations, which may include cellular/Wireless Wide Area Network (WWAN) communications, e.g., a GSM LTE, Wireless Local Area Network (WLAN) communications, e.g., 802.11x, and/or Wireless Personal Area Network (WPAN) communications, e.g., a Bluetooth, 60 GHz communications (millimeter wave interface). The supported wireless operations may also be proprietary in nature. An optional wired interface 212 supports one or more of Local Area Network (LAN) communications, e.g., Ethernet, serial interface communications (for programming and setup), and/or other wired communications. An RF energy collection unit 214 collects energy to support powering of the client device 120 in some operations and may operate similar to an RF tag in collecting energy.

The client device 120 may also include a camera 216 that captures one or more images. The camera 216 may be of reduced resolution but of sufficient resolution to determine if a meaningful visual event has occurred. When the client device 120 detects motion, the camera 216 may be enacted to capture an image. This image may be locally processed as energy is available. Alternately, a pixel pattern may be transmitted to a servicing gateway 112 for further processing.

The MEMS energy harvesting module 206 includes one or both of a MEMS device that converts motion to electrical energy and a MEMS device that converts heat energy into electrical energy. The construct of such MEMS devices is generally known. Energy storage 208 stores the energy captured by the MEMS energy harvesting module 206. The energy storage 208 may be capacitive storage in one embodiment. In other embodiments, the energy storage 208 may be of a differing type such as a rapid charge battery, which stored charge may be quickly dissipated. The energy storage 208 powers the other components of the client device 120. In another operation, the optional RF energy collection unit 214 or the wired interface 212 may be used to provide electrical power to the client device 120, e.g., during programming/setup.

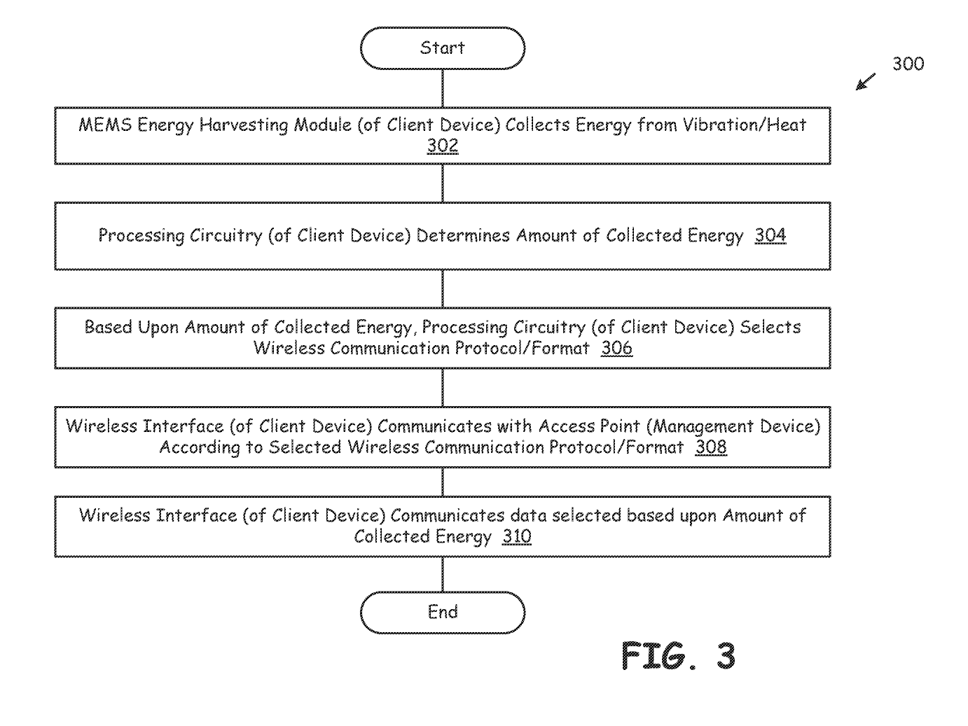

The operations of the client device 120 either alone or in combination with the gateway 112 are described with reference to FIGS. 3-10. According to some aspects of this description, the processing circuitry 202 is operable to determine an amount of energy collected by the MEMS energy harvesting component 206 or stored in the energy storage 208 in response to an energy collection event. The processing circuitry 202 is further operable to, based upon the amount of energy collected, determine wireless communication operations. Finally, the processing circuitry 202 is operable to communicate with a remote device, e.g., device 112 or 114 or another client device 120 of FIG. 1, via the wireless interface 210 according to the determined wireless communication operations.

The determined wireless communication operations may be a communication format for use in communicating with the remote device, a communication frequency band for use in communicating with the remote device, an amount of data to be transmitted to the remote device, a number of transmissions and receipts supported to communicate with the remote device, or another type of communication operation described herein. The communication format may be a type of wireless communication protocol, e.g., 802.11x, Bluetooth, Cellular WWAN, or another standardized communication protocol. The communication frequency band may be the 2.4 GHz, 5 GHz or 60 GHz communication frequency bands.

The processing circuitry 202 may be further configured to communicate with the remote device via the wireless interface 210 according to the determined wireless communication operations by communicating the amount of energy collected for the energy collection event. The MEMS energy harvesting component may be a component that collects energy based upon local vibration and/or a component that collects energy based upon local heat gradient. In such case, in communicating with the remote device via the wireless interface according to the determined wireless communication operations, the communication may include an indication of how energy was collected by the MEMS energy harvesting component during the energy collection event.

According to another aspect of the present disclosure, the client device 120 interacts with one or more monitoring devices, e.g., 112 or 114 of FIG. 1 or another remote monitoring device to report its ‘health.’ Changes in temperature, or other characteristics of the client device 120, or semi conductive components thereof may provide an early warning signal that the client device 120 may be starting to fail or simply have reduced functionality. Indications of the health of client device 120 may be provided by one or more of a wide array of components thereof. Two examples of such components are a temperature detector 203 and ring oscillators 205, which can be used to manage operation of the client device 120 and to track and monitor client device health 120 as indicated by variations in these components over time. In one example, output of the temperature sensor 203 combined with output of the ring oscillators 205 indicates the operational speed of the semi conductive components of the client device 120. Automatic Voltage Select (AVS) operations of the processor 202 may use output of the temperature detector 203 and the ring oscillators 205 to adapt usage of the energy storage 208, via a power supply, to optimize (minimize) the power dissipation during the operation of the client device 120.

Further, the temperature detector 203 and the ring oscillator 205 may also be used to determine the ‘health’ of the component while it's in operation. A drift of the on-chip ring-oscillators 205 or a change in measured temperature via the temperature detector 203 can be transmitted to a monitoring device to provide an early warning that there is a potential issue with the client device 120. Reference parameters for these client devices 120 may be used to determine if the client device 120 is operating in an acceptable operating range. When the operational parameters of the client device 120 fall outside of acceptable operating range parameters, a communication to a monitoring device provides an indication of potential failing ‘health’ of the client device 120. Resultantly, a service technician may be dispatched to service the client device 120.

FIG. 3 is a flow chart illustrating operation of a system operating according to one or more embodiments of the present disclosure. Operations 300 commence with a client device collecting energy by the device being moved/vibrating or being exposed to a heat source. In such case, the MEMS energy harvesting module of the client device collects energy from the vibration/heat (Step 302). The user will appreciate that the amount of energy collected by the MEMS energy harvesting module depends upon the size of the stimulation. For example, if the client device is moved quickly and/or repeatedly, the MEMS energy harvesting module collects relatively more energy than for minor motion. Likewise, if the MEMS energy harvesting module collects energy by being exposed to a heat gradient, the larger the heat gradient, the more energy that will be collected.

Operation continues with the processing circuitry of the client device determining an amount of energy that was collected by the MEMS energy harvesting module by the stimulating event (Step 304). Such determination may be made by query of or measurement of the energy storage 208 of the client device 120. In some embodiments, the energy storage 208 may include energy level measuring circuitry. In other embodiments, the processing circuitry or other circuitry of the client device measures the amount of energy stored in the energy storage 208.

Based upon the amount of energy that was collected, the processing circuitry of the client device selects a wireless communication protocol/format for usage (Step 306). Because, in many operations, the only energy that is available for operation of the client device 120 is collected by a triggering event, e.g., mechanical motion/vibration or heat gradient, the client device 120 must complete its designated operations prior to all operational energy being depleted from the energy storage 208. Thus, the processing circuitry determines what communication protocol/format to use that is supportable based upon the level of energy collected. This communication protocol/format may be one a plurality of standardized formats, e.g., one of IEEE 802.11x, Bluetooth, a cellular format, a 60 GHz format, etc. The communication protocol/format may also be differing operations of a particular standardized format, e.g., one option of IEEE 802.11x, one option of Bluetooth, etc. The client device than communicates via its wireless interface using the selected wireless communication protocol/format (Step 308).

Further, the client device communicates data that is also selected based upon the amount of collected energy (Step 310). For relatively smaller amounts of collected energy first data may be transmitted, e.g., that an energy collection event was detected, while for relatively larger amounts of collected energy second data may be transmitted, e.g., that a significant energy collection even was detected. The operations of Step 310 may include comparing an amount of energy collected to one or more energy collection thresholds and, based upon the comparison, particular data may be selected and transmitted. Thus, the client device 120 may include sufficient processing to discern the magnitude of the energy collection event and operate accordingly.

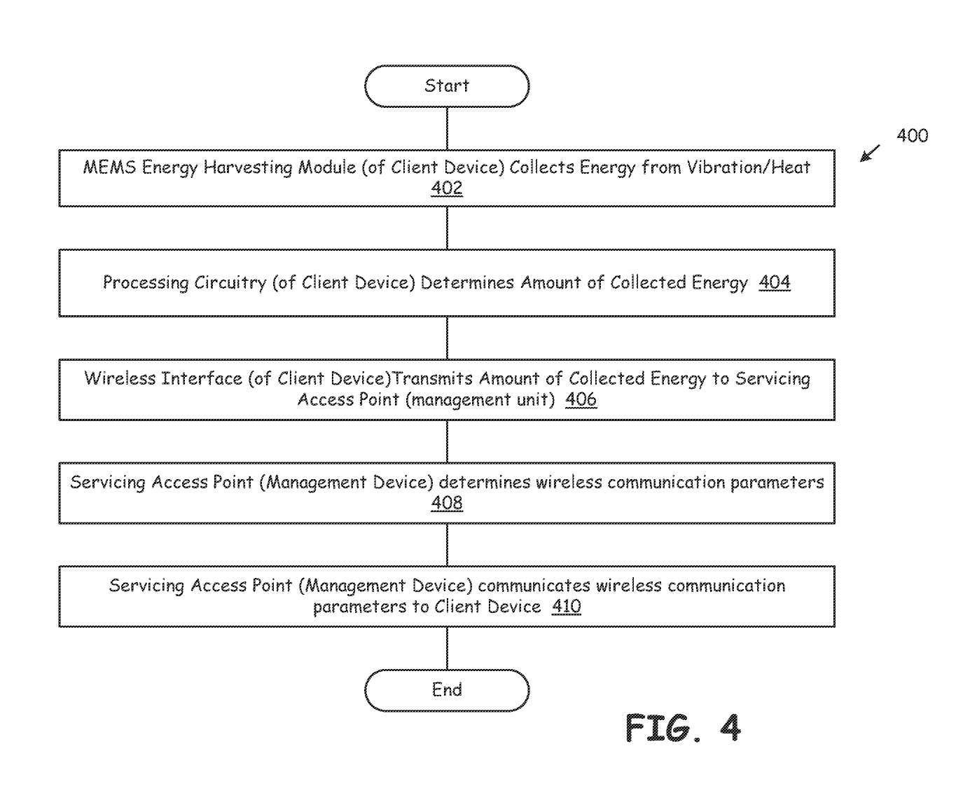

FIG. 4 is a flow chart illustrating operation of a system operating according to one or more embodiments of the present disclosure. The operations 400 of FIG. 4 commence with the client device capturing electrical energy via its MEMS energy harvesting module via a stimulating event of motion or localized heat gradient (Step 402). The processing circuitry of the client device then determines the amount of collected energy, same/similar to the operations of step 304 of FIG. 3 (Step 404). The wireless interface of the client device then transmits to the gateway 112 (or other remote device) the measured amount of the energy collected by the MEMS energy collection module (Step 406). In another embodiment this data is transmitted via the wired link. In response thereto, the gateway 112 (or other servicing access point) determines wireless communication parameters that will be used for communicating with the client device 120 (Step 408). Then gateway 112 (or other servicing access point) then communicates with the client device via the determined communication parameters (Step 410). Note that the client device 120 and the gateway may independently arrive at the same communication parameter decision based upon the level of energy collected.

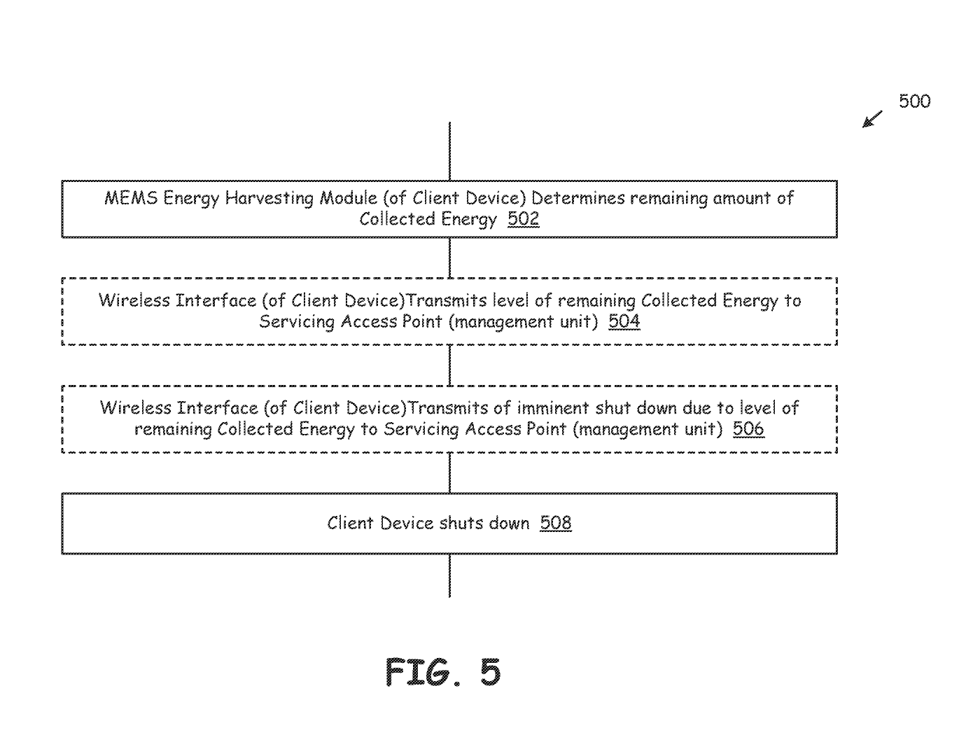

FIG. 5 is a flow chart illustrating operation of a client device operating according to one or more embodiments of the present disclosure. Operations 500 commence with the client device determining a remaining amount of collected energy (that was previously collected by the MEMS energy harvesting module) (Step 502). The operations 500 of FIG. 5 may be performed periodically at all times that the client device is powered up after collecting energy via a proximate vibration or heat gradient event. The client device then optionally transmits a level of remaining collected energy to a servicing gateway 112 (management unit) (Step 504). The client device further may transmit to the servicing gateway 112 notice of an imminent shut down due to the level of the collected energy remaining (Step 506). The client device then shuts down (Step 508).

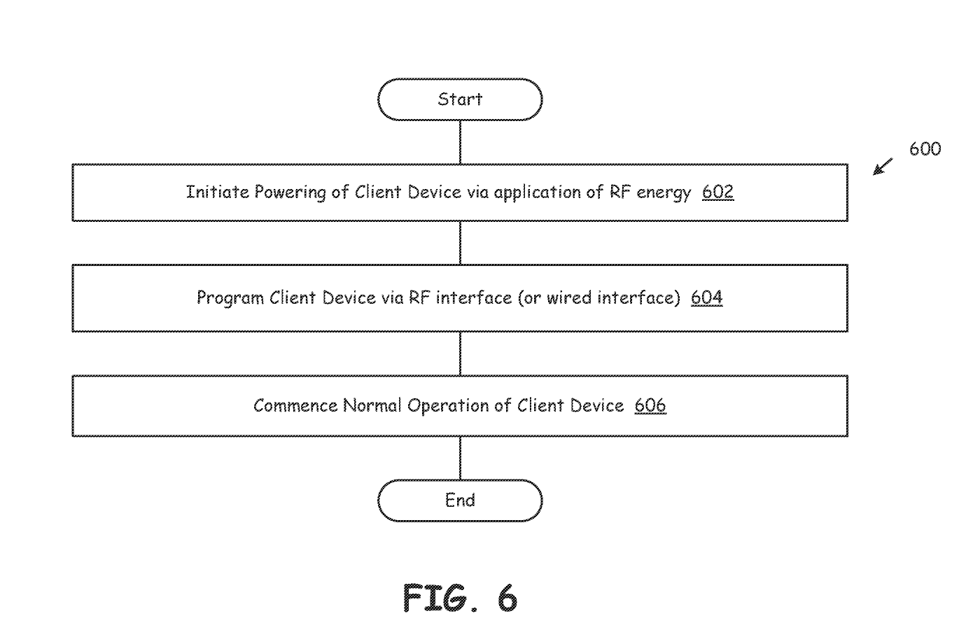

FIG. 6 is a flow chart illustrating programming/configuration operation of a client device operating according to one or more embodiments of the present disclosure. The programming/configuration operations 600 of FIG. 6 may be performed in the factory, during system setup at a vendor location, or on-site once the client device is installed. Continuing the example of FIG. 1, each client device 120 may have a particular function including, for example: (1) a motion sensor that detects vibration caused by localized motion, e.g., person or animal; (2) a heat sensor that detects a local heat gradient caused by the proximal position of a person or animal; or (3) a motion sensor that detects the positional change of a window or door.

The client device 120 may be programmed via a wireless link or a wired link. The client device 120 may be powered by the application of wired power via a wired interface, via applied vibration, via applied heat gradient, or via application of RF power. With the embodiment of FIG. 6, the operations 600 commence with the initiation of powering of the client device via application of RF energy (Step 602). The client device 120 is then programmed via the RF interface or via the wired interface (604). Then, once the client device 120 is programmed, its normal operations commence (606).

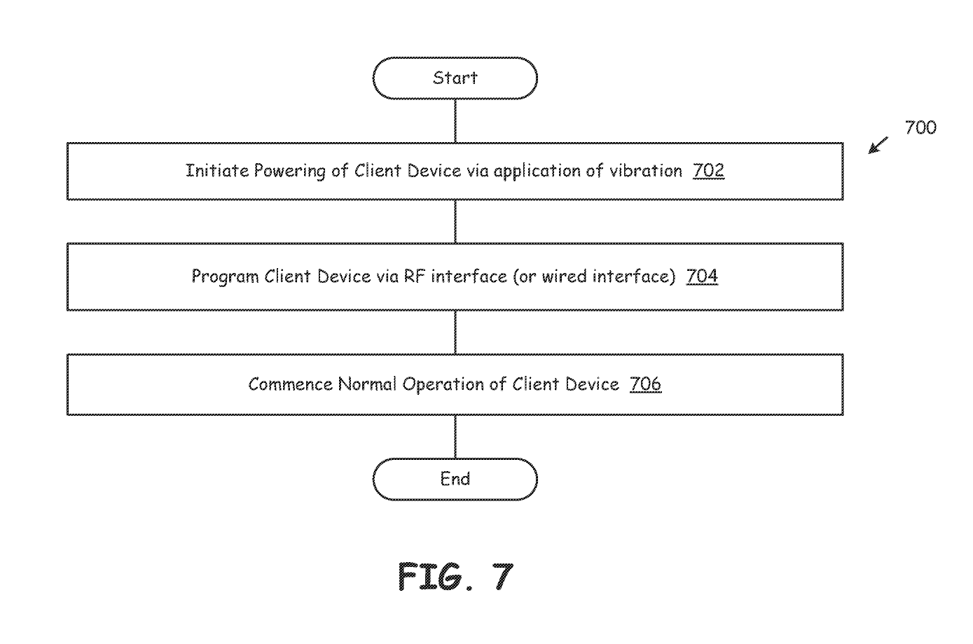

FIG. 7 is a flow chart illustrating programming/configuration operation of a client device operating according to one or more embodiments of the present disclosure. With the embodiment of FIG. 7, operations 700 include powering of the client device 120 via the application of vibration (Step 702). Such application of vibration may be performed by a hand-held unit that includes a mechanical vibration source that is employed to power the client device 120 and an RF interface (or wired interface) that is used to program the client device 120. The client device 120 is then programmed via its RF interface or its wired interface (Step 704). Once the client device is specially programmed normal operation commences (Step 706).

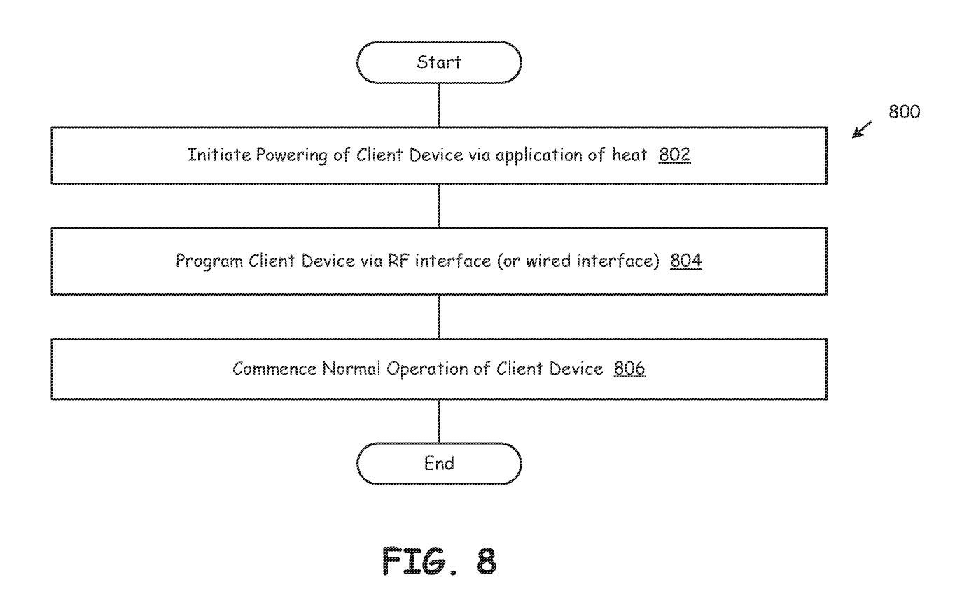

FIG. 8 is a flow chart illustrating programming/configuration operation of a client device operating according to one or more embodiments of the present disclosure. With the embodiment of FIG. 8, operations 800 include powering of the client device 120 via the application of heat (Step 802). Such application of heat may be performed by a hand-held unit that includes a heat source that is employed to power the client device 120 and an RF interface (or wired interface) that is used to program the client device 120. The client device 120 is then programmed via its RF interface or its wired interface (Step 804). Once the client device is specially programmed normal operation commences (Step 806).

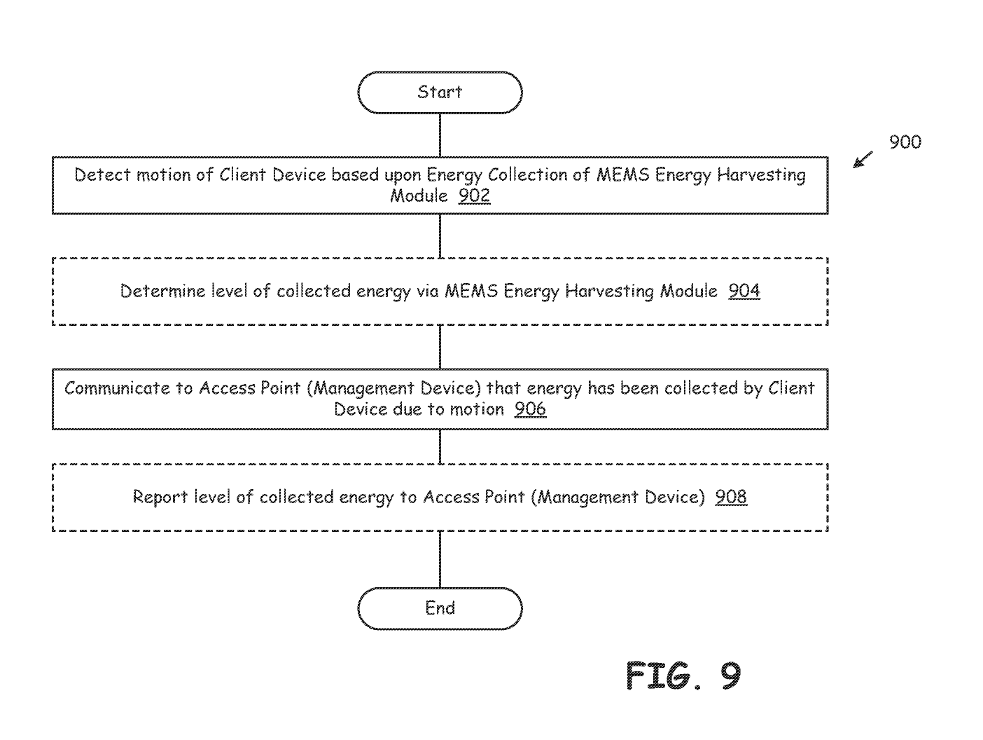

FIG. 9 is a flow chart illustrating operation of a system operating according to one or more embodiments of the present disclosure. The operations 900 of FIG. 9 are performed once the client device is placed in service. The operations 900 commence with the client device detecting motion based upon the collection of energy via its MEMS energy harvesting module (Step 902). The energy collected may be via vibration energy or heat energy. The client device 120 then optionally determines the level of energy collected by the MEMS energy harvesting module (Step 904). The client device 120 then communicates to a servicing gateway 112 that energy has been collected by the client device 120 (Step 906). Note that, as distinguished from prior described operations the client device 120 does not necessarily communicate a level of energy collected but communicates that energy is collected.

For example, when the client device 120 is installed as a door motion sensor, the client device 120 effectively communicates that the door has changed positions. Likewise, with the client device 120 collecting energy based upon a detected heat gradient, the client device 120 only determines a proximal heat source and does not necessarily determine the level of energy detected, only that energy was collected. The servicing gateway 112, being notified of an energy collection event may take further steps to determine if the event is meaningful and, in some operations, collect additional information, e.g., via a camera or other motion sensor. In an optional operation, the client device 120 reports the level of energy collected to the servicing gateway 112 (Step 908).

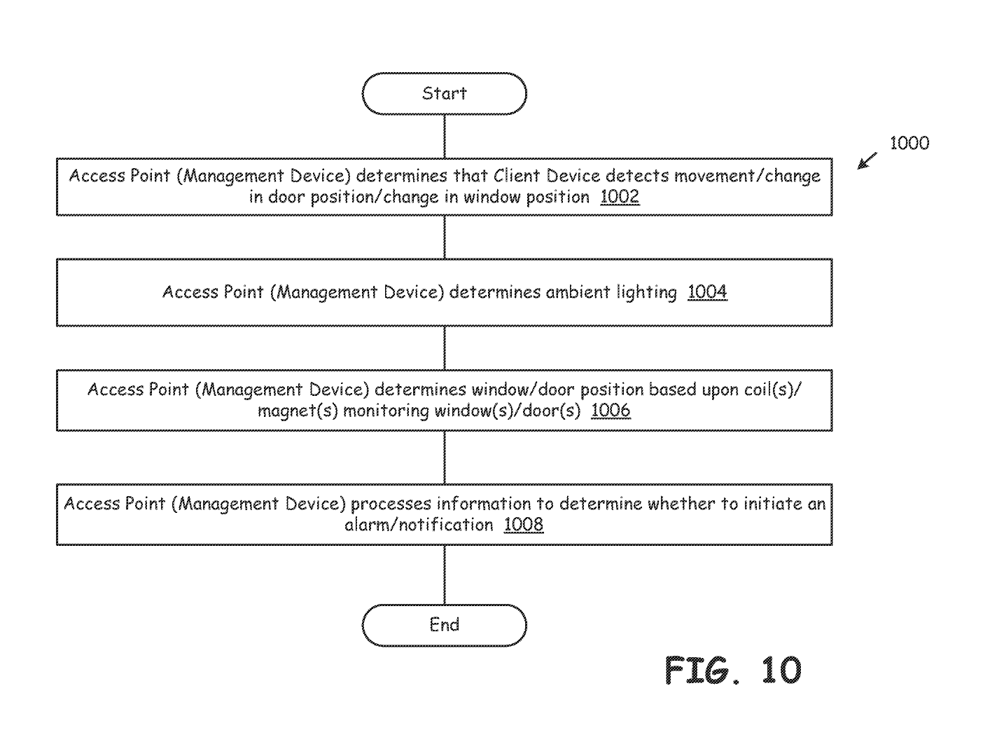

FIG. 10 is a flow chart illustrating operation of a system operating according to one or more embodiments of the present disclosure. The operations 1000 of FIG. 10 commence with the servicing gateway 112 determining that a client device 120 detects movement/change in door position/change in window position (Step 1002). Such determination is made via a client device 120 reporting an energy event to the servicing gateway and the servicing gateway 112, based upon the location and installation function of the client device 120, making such determination. For example, the reporting client device 120 may be installed in a front door or, alternately, in a window towards a rear portion of a serviced premises. In response to this report, the servicing gateway 112 determines an ambient lighting condition (Step 1004), e.g., is it night, during the day, at dusk, etc. The servicing gateway 112 then determines an actual position of the door/window via a coil or other monitoring circuitry (Step 1006). The servicing gateway 112 then processes this information to determine whether to an initiate an alarm/notification (Step 1008)

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with,” includes direct and/or indirect coupling of separate items and/or one item being embedded within another item.

As may also be used herein, the term processing circuitry may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing circuitry may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing circuitry includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing circuitry implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing circuitry, and/or processing unit executes, hard coded and/or operational instructions corresponding to at least some of the steps and/or functions illustrated in one or more of the FIGS. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof. In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from FIG. to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a FIG. of any of the FIGS. presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

While particular combinations of various functions and features of the one or more embodiments have been expressly described herein, other combinations of these features and functions are likewise possible. The present disclosure is not limited by the particular examples disclosed herein and expressly incorporates these other combinations.

1. A wireless device comprising:
a wireless interface;
a Micro Electro-Mechanical System (MEMS) energy harvesting component;
energy storage coupled to the MEMS energy harvesting component; and
processing circuitry coupled to at least some of the wireless interface, the MEMS energy harvesting component, and the energy storage, the processing circuitry configured to:
determine an amount of energy collected by the MEMS energy harvesting component or stored in the energy storage in response to an energy collection event;
based upon the amount of energy collected, determine wireless communication operations; and
communicate with a remote device via the wireless interface according to the determined wireless communication operations.

2. The wireless device of claim 1, wherein the determined wireless communication operations comprise a communication format for use in communicating with the remote device.

3. The wireless device of claim 1, wherein the determined wireless communication operations comprise a communication frequency band for use in communicating with the remote device.

4. The wireless device of claim 1, wherein the determined wireless communication operations comprise an amount of data to be transmitted to the remote device.

5. The wireless device of claim 1, wherein the processing circuitry is further configured to communicate with the remote device via the wireless interface according to the determined wireless communication operations by communicating the amount of energy collected for the energy collection event.

6. The wireless device of claim 1:
further comprising at least one of a temperature detector or a ring oscillator;
wherein the processing circuitry is further configured to detect its operational health based upon output of the temperature detector or the ring oscillator; and
wherein the processing circuitry is further configured to adjust its operation based upon the operational health or report the operational health to the remote device.

7. The wireless device of claim 1, wherein the MEMS energy harvesting component comprises:
a component that collects energy based upon local vibration; and
a component that collects energy based upon local heat gradient,
wherein communicating with the remote device via the wireless interface according to the determined wireless communication operations comprises an indication of how energy was collected by the MEMS energy harvesting component during the energy collection event.

8. A method for operating a wireless device comprising:
harvesting energy via a Micro Electro-Mechanical System (MEMS) energy harvesting component;
storing the harvested energy in an energy storage;
determining an amount of energy collected by the MEMS energy harvesting component or stored in the energy storage in response to an energy collection event;
based upon the amount of energy collected, determining wireless communication operations; and
communicating with a remote device via a wireless interface according to the determined wireless communication operations.

9. The method of claim 8, wherein the determined wireless communication operations comprise a communication format for use in communicating with the remote device.

10. The method of claim 8, wherein the determined wireless communication operations comprise a communication frequency band for use in communicating with the remote device.

11. The method of claim 8, wherein the determined wireless communication operations comprise an amount of data to be transmitted to the remote device.

12. The method of claim 8, wherein communicating with the remote device via the wireless interface according to the determined wireless communication operations comprises communicating the amount of energy collected for the energy collection event.

13. The method of claim 8, further comprising:
detecting operational health of the wireless device based upon output of a temperature detector or a ring oscillator; and
adjusting operation of the wireless device based upon the operational health or communicating the operational health to the remote device.

14. The method of claim 8, wherein:
collecting energy by the MEMS energy harvesting component comprises at least one of collecting energy based upon local vibration collecting energy based upon local heat gradient; and
communicating with the remote device via the wireless interface according to the determined wireless communication operations comprises indicating to the remote device how energy was collected by the MEMS energy harvesting component during the energy collection event.

15. A wireless device comprising:
a wireless interface that supports wireless communications according to a plurality of differing wireless communication protocols;
a Micro Electro-Mechanical System (MEMS) energy harvesting component;
energy storage coupled to the MEMS energy harvesting component; and
processing circuitry coupled to at least some of the wireless interface, the MEMS energy harvesting component, and the energy storage, the processing circuitry configured to:
determine an amount of energy collected by the MEMS energy harvesting component or stored in the energy storage in response to an energy collection event;
based upon the amount of energy collected, selecting a wireless communication protocol from the plurality of wireless communication protocols; and
communicate with a remote device via the wireless interface according to the selected wireless communication protocol.

16. The wireless device of claim 15:
wherein the wireless interface further supports wireless communications in a plurality of differing communication frequency bands;
wherein the processing circuitry is further configured to, based upon the amount of energy collected, select a wireless communication frequency band from the plurality of differing communication frequency bands; and
wherein the processing circuitry is further configured to communicate with the remote device via the wireless interface according to the selected wireless communication frequency band.

17. The wireless device of claim 15, wherein the processing circuitry is further configured to determine, based upon the amount of energy collected, an amount of data to be transmitted to the remote device.

18. The wireless device of claim 15, wherein the processing circuitry is further configured to communicate to the remote device via the wireless interface the amount of energy collected for the energy collection event.

19. The wireless device of claim 15:
further comprising at least one of a temperature detector or a ring oscillator;
wherein the processing circuitry is further configured to detect operational health of the wireless device upon output of the temperature detector or the ring oscillator; and
wherein the processing circuitry is further configured to adjust its operation based upon the operational health or to communicate the operational health to the remote device.

20. The wireless device of claim 1, wherein the MEMS energy harvesting component comprises:
a component that collects energy based upon local vibration; and
a component that collects energy based upon local heat gradient,
wherein the processing circuitry is further configured to an indication of how energy was collected by the MEMS energy harvesting component during the energy collection event.
